(19) United States
(12) Patent Application Publication
(10) Pub. No.: US 2005/0262358 A1
(43) Pub. Date: Nov. 24, 2005

(54) Backing context for portal element controls

(75) Inventor: Chris Jolley, Broomfield, CO (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 11/131,619

(22) Filed: May 18, 2005

Related U.S. Application Data
(60) Provisional application No. 60/573,267, filed on May 21, 2004.

(51) Int. Cl. H04K 1/00

(52) U.S. Cl. 713/182

(57) ABSTRACT

Backing files and backing contexts can be associated with portal elements controls for the construction of a portal. The backing files and backing contexts can allow interactions with the portal element controls before rendering. In one embodiment, developers are allowed to have access to backing files and backing contexts. The backing files allows developer code to be run before rendering. The backing contexts allow the setting and getting of information from the portal element controls.

### CLAIM OF PRIORITY

This application claims priority to U.S. Provisional Application No. 60/573,267 entitled “Backing Files and Backing Context for Portal Element Controls” filed May 21, 2004, by Chris Jolley. [Attorney's Docket No.: BEAS-01612US0]

### FIELD OF THE INVENTION

The present invention is directed to portal technology.

### BACKGROUND

Portals can provide access to information networks and/or sets of services through the World Wide Web and other computer networks. Portals can provide a single point of access to data and applications, making them valuable to developers, businesses, and consumers alike. A portal can present a unified and personalized view of enterprise information to employees, customers, and business partners. In many implementations, portal applications can include web application views designed as a portal.

Portals are capable of presenting multiple web application views within a single web interface. In addition to regular web content that can appear in a portal, portals provide the ability to display portlets (self-contained applications or content) in a single web interface. Portals can also support multiple pages with menu-based or custom navigation for accessing the individualized content and portlets for each page.

A working portal can be defined by a portal configuration. The portal configuration can include a portal definition such as a file including Extensible Markup Language (XML); portlet definition files for any portlets associated with the portal; java server pages (JSPs); web application descriptors; images such as graphics interchange format files (GIFs); deployment descriptors, configuration files, thejava archive (JAR) files that contain the logic and formatting instructions for the portal application; and any other files necessary for the desired portal application.

### BRIEF DESCRIPTION OF THE FIGURES

FIG. 1 is a diagram that illustrates a portal element control, backing file, and backing context.

FIG. 2 illustrates the construction of a control tree of portal element controls produced from a portal file.

FIG. 3 illustrates a system of one embodiment of the present invention.

### DETAILED DESCRIPTION

Portals can provide access to information networks and/or sets of services through the World Wide Web (WWW) or other computer networks. These networks can range from broad interconnections of computing systems such as the Internet to localized area networks including a few computers located in close geographic proximity such as a home or office. Portal applications can include web application views designed as a portal.

Portlets can be implemented as java server pages (JSPs) referenced by XML-based metadata of the portal descriptor. Portlets can utilize various types of display code to display highly focused information directed to a specific user or user group, having a portal as its container. Portlets can be comprised of portlet components which include portlet attributes (i.e. whether the portlet is editable, floatable, minimizable, maximizable, helpable, mandatory, has defaults minimized, or whether login is required) and portlet layout elements or components (i.e. banner, header, content, and footer sections). In one embodiment, a portlet is defined by a file that contains a portlet's XML-based metadata, which is created and edited by an integrated design environment or administration tool. Portlets can also be associated with portlet resource files including skeleton JSPs (one for each portlet layout element) and image files saved to a local file system by portal designer of integrated design environment.

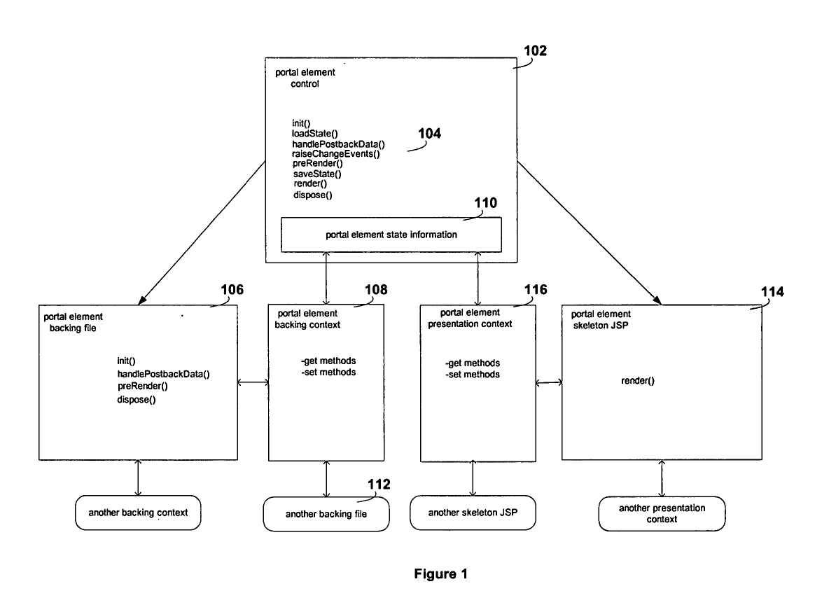

FIG. 1 illustrates a portal element control 102. Portal elements can include the desktop, books, pages, portlets, menus, layouts and Java Server Page (JSP) content. The portal element controls and backing files can be for desktops, books, pages, portlets, JspContent or other portal elements. The portal element control can be a Java class that extends a main UIcontrol class. The portal element controls allow for the construction of the portals and the interactions of portal elements. The portal element control 102 can include lifecycle methods 104. The lifecycle methods 104 can be performed in a predetermined order. In one embodiment, a number of the methods are done before rendering the portal element. The lifecycle methods can include init( ), loadstate( ), handlePostbackData( ), raiseChangeEvents( ), preRender( ), savestate( ), render( ) and dispose( ).

In one embodiment, the portal element controls are not directly exposed to developers. Backing files and backing context and other structures can be used to allow the developer to interact with a portal element control. The backing context and backing files can restrict the developers access to the portal file controls. This allows the portal element control code to be updated and improved without damaging developers' implementations as long as the interactions with the backing file and backing context are supported.

The backing file can include code provided by the developer. The portal element control 102 can use backing file code of the backing file 105 in at least one lifecycle method before the rendering of the portal element.

In one embodiment, the developer can write backing code for the backing file to allow the developer to run business logic, modify the portal element display, cause events catch events and do other functions before doing the rendering. For example, the backing file can allow code to be run for the lifecycle methods init( ), handlePostbackData( ), and preRender( ) before the portal element is rendered and allow code to be run for dispose( ) after the portal element is rendered. A new instance of the backing file can be created for each request so that the backing files can be thread safe.

A backing context 108 can allow access to methods to affect state information 110 of the portal element control before the rendering of the portal element.

The backing context 108 can allow access to get methods to read portal element state information and allow access to set methods to write portal element state information. The methods of the backing context can hide some portal element control methods from the developers. The backing context 108 can be called by other backing files, such as backing file 112.

A portal element skeleton JSP 114 can be used by the portal element control 102 during the rendering of the portal element. The developer can write skeleton JSP code to affect the rendering of the portal element.

A presentation context 116 allows access to methods to affect state information of the portal element control during the rendering of the portal element. A portal element skeleton JSP can use the presentation context 116 to access the portal state information.

One method of the present invention uses a portal element control 102 along with a backing context 108 for the portal element control. The backing context 108 can allow access to methods 104 to affect state information 110 of the portal element control 102 before the rendering of the portal element.

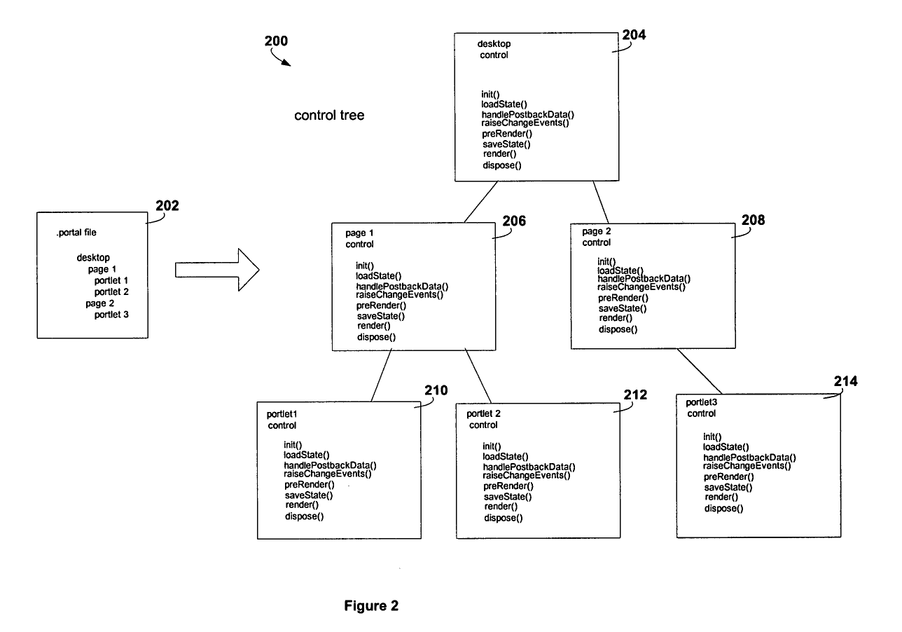

FIG. 2 shows the construction of a control tree 200 of portal element controls from a portal file 202. In one embodiment, the hierarchy of the portal elements defined in the portal file 202 is used to construct the control tree 200. In the example of FIG. 2, the desktop control 204 has children: page1 control 206 and page2 control 208; page1 control 206 has children: portlet1 control 210 and portlet2 control 212; and page2 control 208 has a child portlet3 control 214. A portal configuration stored in a database can also be used to construct a control tree including portal element controls.

The methods of the control tree can be called in order of the lifecycle methods. For example, all of the init( ) methods can be called by followed by all of the loadState( ) methods, and so on. In one embodiment, the methods are called in depth first order. For the example of FIG. 2, the init( ) for the desktop control 204 is called, followed by the init( ) for the page1 control 206, followed by the init( ) for the portlet1 control 210, followed by the init( ) for the portlet2 control 212 and the init( ) for the page2 control 208 followed by the init( ) for the portlet 3 control 214. The loadState( ) and other lifecycle methods are called in the same depth first order. In alternate embodiments, the lifecycle methods can be called in another order.

During certain of the lifecycle methods, the code in the backing files associated with each of the portal element controls can be run. These can also be run in a predetermined order, such as the depth-first order described above. For example, during the init( ) stage of portal element control, a backing file correspond to the page1 control 206 can be called. If there is code written by the developer in the backing file for the init( ) method, this code can be run. In one embodiment, the code can get information from another control or set information from another control using the backing context of the other portal element control. The backing file can also set and get events. For example, the backing file can set an event which later can be searched for by another backing file.

The ability to get and set information concerning the portal element controls using backing files allows the user to, for example, change the title of a portlet or change other display information, minimize a portlet or do a variety of actions before the rendering phase. The backing files provide an easy way to allow portal elements to affect rendering of other portal elements before the rendering phase.

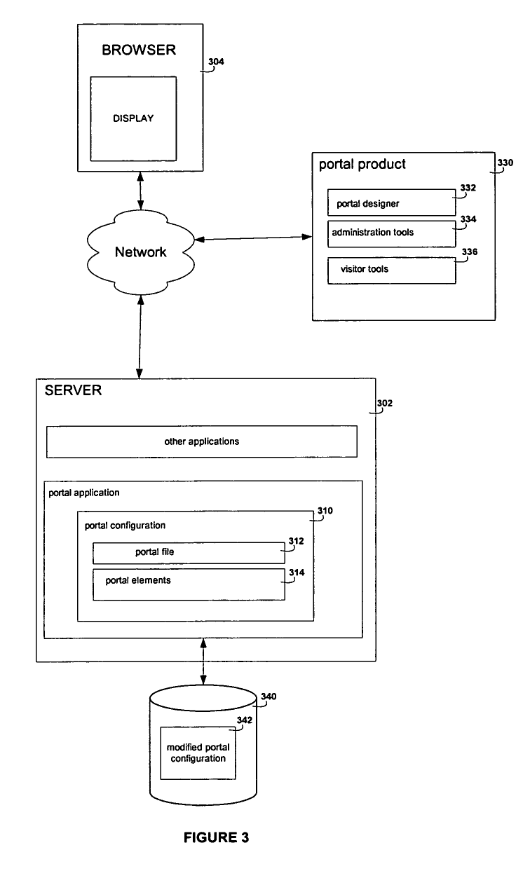

FIG. 3 illustrates a system for implementing one embodiment of the present invention. Server 302 can be used to produce the portal for display at the browser 304. In one embodiment, the server 302 produces a portal display in response to a request from the browser client 304. The portal can be configured for different users and different groups of users, where different portlets can be displayed based upon a user's group or role. The server 302 can use a portlet configuration 310. The portlet configuration can include a portal file 312 which can be an XML file indicating the portal elements. The server 302 can use portal file 312 to construct a control tree of the portal element controls. The portal element controls can execute to produce the portal.

The server 302 can be software that can be run on one or more server machines. In one embodiment, the server 302 is the WebLogic Server™ available BEA Systems Inc., of San Jose, Calif.

A portal product 330 can be an Integrated Designed Environment (IDE) for producing the portal. In one embodiment, the IDE includes a portal designer 332 for the design of the portal, portlets and other portal elements. The administration tools 334 and visitor tools 336 are used for producing versions of the portal. In one embodiment, different versions use the portal configuration 310 to produce a modified portal configuration 342 that can be stored in a database 340. Portals can be produced from the database 340, a cache or directly from the portal configuration 310.

Appendix I shows a non-limiting example of one embodiment. For example, the discussion of the implementation of the portal element controls, backing files and backing context described in the Appendix I are understood to concern one embodiment and are not meant or believed to have the effect of limiting the meaning of these terms. The Appendix I is provided to illustrate how these concepts can be implemented in one exemplary embodiment.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, micro drive, and magneto-optical disks, ROMs, Rams, EPROM's, EPROM's, Drams, Rams, flash memory devices, magnetic or optical cards, Nanoscale systems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps performed in the embodiments of the invention disclosed can be performed in alternate orders, certain steps can be omitted, and additional steps can be added. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

Note: The memory size calculated is not accurate.

### Portlet Content

The portlet's content is referenced by contentUri element in “.portlet” file, if it is expensive to compute content every time, consider using rendercacheable portlet attributes to cache portlet's content or if the portlet's content type is jsp, consider using wl:cache jsp tags to cache static portions within a jsp.

### JVM Parameter Values

The following JVM parameters shown in Table 1.0 proved to be the best for the hardware configurations listed in Table 2.0.

TABLE 1.0
High Performing JVM Darameters

| JYM | W2K | Linux | Solaris |
|---|---|---|---|
| BEA | Xms1024 | Xms1024 | Xms1024 |
| jrockit81sp2_141_05 | Xmx1024 | Xmx1024 | Xmx1024 |
| | Xgc:parallel | Xgc:parallel | Xgc:parallel |
| JDK1.4.1_05 | Xms1024 | Xms1024 | Xms1024 |
| serverVM | Xmx1024 | Xmx1024 | Xmx1024 |
| | XX: NewRatio=2 | XX:NewRatio=2 | XX:NewRatio=2 |
| | XX:MaxPermSize=128m | XX:+UseParallelGC | XX:+UseParallelGC |
| | | XX:MaxPermSize=128m | XX:MaxPermSize=128m |

TABLE 2.0
Hardware used in WLP8.1 sp2 load testing

| Platform | CPUs * | | Physical | CPU | Hardware | |
|---|---|---|---|---|---|---|
| Name | CPU speed | CPU type | Memory | bits | Model | OS |
| W2K | 1 * 3.0 GHz | Intel | 2048 MB | 32 | Dell 650 | Microsoft Windows 2000, |
| | | Pentium ® 4 | | | | Advanced Server |
| Linux | 1 * 3.0 GHz | Intel | 2048 MB | 32 | Dell 650 | Red Hat Linux Advanced |
| | | Pentium ® 4 | | | | Server release 2.1AS/i686 |
| | | | | | | (Pensacola) |
| Solaris | 2 * 1002 MHz | Sun's sparcv9 | 2048 MB | 64 | Sun 240V | SunOS 5.9 |
| | | processor | | | | |

1. A portal including:
a portal element control; and
a backing context for the portal element control, the backing context allowing access to methods to affect state information of the portal element control before the rendering of the portal element.

2. The portal of claim 1, wherein a backing file uses the backing context.

3. The portal of claim 1, wherein the backing context allows access to get methods.

4. The portal of claim 3, wherein the get methods obtain portal element state information.

5. The portal of claim 1, wherein the backing context allows access to set methods.

6. The portal of claim 5, wherein the set methods set portal element state information.

7. The portal of claim 5, wherein a presentation context allows access to methods to affect state information of the portal element control during the rendering of the portal element.

8. The portal of claim 1, wherein a portal file is used to construct a control tree including portal element controls.

9. The portal of claim 1, wherein a portal configuration stored in a database is used to construct a control tree including portal element controls.

10. The portal of claim 1, wherein the backing file allows access to a restricted set of methods.

11. A method comprising:
constructing a portal using a portal element control; and
using a backing context to access to methods to affect state information of the portal element control before the rendering of the portal element.

12. The method of claim 11, wherein a backing file uses the backing context.

13. The method of claim 11, wherein the backing context allows access to get methods.

14. The method of claim 13, wherein the get methods obtain portal element state information.

15. The method of claim 11, wherein the backing context allows access to set methods.

16. The method of claim 15, wherein the set methods set portal element state information.

17. The method of claim 15, wherein a presentation context allows access to methods to affect state information of the portal element control during the rendering of the portal element.

18. The method of claim 11, wherein a portal file is used to construct a control tree including portal element controls.

19. The method of claim 11, wherein a portal configuration stored in a database is used to construct a control tree including portal element controls.

20. A machine readable medium having instructions stored thereon that when executed by a processor cause a system to:
construct a portal using a portal element control; and
using a backing context to access to methods to affect state information of the portal element control before the rendering of the portal element.
